(19) United States
(12) Patent Application Publication
(10) Pub. No.: US 2010/0122171 A1
(43) Pub. Date: May 13, 2010

(54) NON-LINEAR SLIDE PRESENTATION MANAGEMENT FOR SLIDE SHOW PROGRAMS

(76) Inventors: Feredric Bauchot, Saint-Jeannet (FR); Denis Esteve, Vence (FR); Gerald Marmigere, Drap (FR); Carol Truntschka, St. Laurent du Var (FR)

Correspondence Address: HOFFMAN WARNICK LLC, 75 STATE ST, 14 FL, ALBANY, NY, 12207, US

(21) Appl. No.: 12/277,342

(22) Filed: Nov. 25, 2008

(30) Foreign Application Priority Data
Nov. 7, 2008 (EP) 08305786.9

(51) Int. Cl. G06F 3/048

(52) U.S. Cl. 715/732

(57) ABSTRACT

A non-linear slide presentation management for slide show programs. In a first aspect, the invention provides a method for non-linear slide presentations, comprising: interrupting a topic sequence of a slide presentation being currently shown; placing a slide identifier from the interrupted topic sequence on a stack; showing a new topic sequence of the slide presentation; and upon completion of the new topic sequence of the slide presentation, returning to the interrupted topic sequence by examining the stack to obtain the slide identifier from the interrupted topic sequence.

### FIELD OF THE INVENTION

The present invention relates generally to slide show programs, and more particularly to the non-linear slide presentation management for slide show programs.

### BACKGROUND OF THE INVENTION

Slide show programs have been developed to help a user in creating, editing, developing and managing slide presentations on a computer. Generally, a slide show contains several electronic slides that display information to an audience. Each slide may be presented as a screen or a page output. Moreover, each slide show may contain one or more objects, such as text, graphical images, animation or sound.

To initiate a presentation, a user calls the “slide show” functionality to sequentially display the slides contained in the presentation on a computer display or to project it on any other surface. During this operation, the user controls the progress of the presentation by invoking a command to “go to the next slide” or automatically by a configured timer for each transition.

Typically, during a meeting, speakers are using a unique slide presentation saved in a linear progression in a specific directory. Transitions, actions, or launch of slide presentations are performed using a remote control or manually. When a speaker receives a question from the audience, he may need support from slide(s) available in his presentation, but not readily available via a simple transition such as advancing to the next or previous slide. In other words, he may need to execute several slide transitions manually or using a remote control to reach the valid slide or slides in the slide presentation.

The above manual processing presents important drawbacks. The main drawback is that the manual action is performed in a repetitive manner and thus is open to human errors, such as going backwards instead of forwards.

Consequently, a need exists to manage a non-linear slide presentation of a slide show program.

### SUMMARY OF THE INVENTION

The present invention addresses the above-mentioned problems, as well as others, by providing a method, system and program product to improve the management of non-linear slide presentations of slide show programs.

In a first aspect, the invention provides a method for non-linear slide presentations, comprising: interrupting a topic sequence of a slide presentation being currently shown; placing a slide identifier from the interrupted topic sequence on a stack; showing a new topic sequence of the slide presentation; and upon completion of the new topic sequence of the slide presentation, returning to the interrupted topic sequence by examining the stack to obtain the slide identifier from the interrupted topic sequence.

In a second aspect, the invention provides a slide sequence management system for non-linear slide presentations, comprising: a sequence interruption system for interrupting a topic sequence of a slide presentation being currently shown; a stack manager system for placing a slide identifier from the interrupted topic sequence on a stack; and a sequence determination system for: showing a new topic sequence of the slide presentation; and upon completion of the new topic sequence of the slide presentation, returning to the interrupted topic sequence by examining the stack to obtain the slide identifier from the interrupted topic sequence.

In a third aspect, the invention provides a program product stored on a computer readable medium for non-linear slide presentations, comprising: at least one computer; the computer readable medium comprising program code for performing the following steps: interrupting a topic sequence of a slide presentation being currently shown; placing a slide identifier from the interrupted topic sequence on a stack; showing a new topic sequence of the slide presentation; and upon completion of the new topic sequence of the slide presentation, returning to the interrupted topic sequence by examining the stack to obtain the slide identifier from the interrupted topic sequence.

The illustrative aspects of the present invention are designed to address at least one of the problems herein described and other problems not discussed.

### BRIEF DESCRIPTION OF THE DRAWINGS

The above and other objects, features and advantages of the invention will be better understood by reading the following more particular description of the invention in conjunction with the accompanying drawings.

FIG. 1 depicts a slide sequence management system for non-linear slide presentations in accordance with the present invention.

FIG. 2 is a flow chart of the main steps for non-linear slide presentations in accordance with the present invention.

FIG. 3 is a topics table for non-linear slide presentations in accordance with the present invention.

FIG. 4 is an illustration of an example of a non-linear slide show presentation in accordance with the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

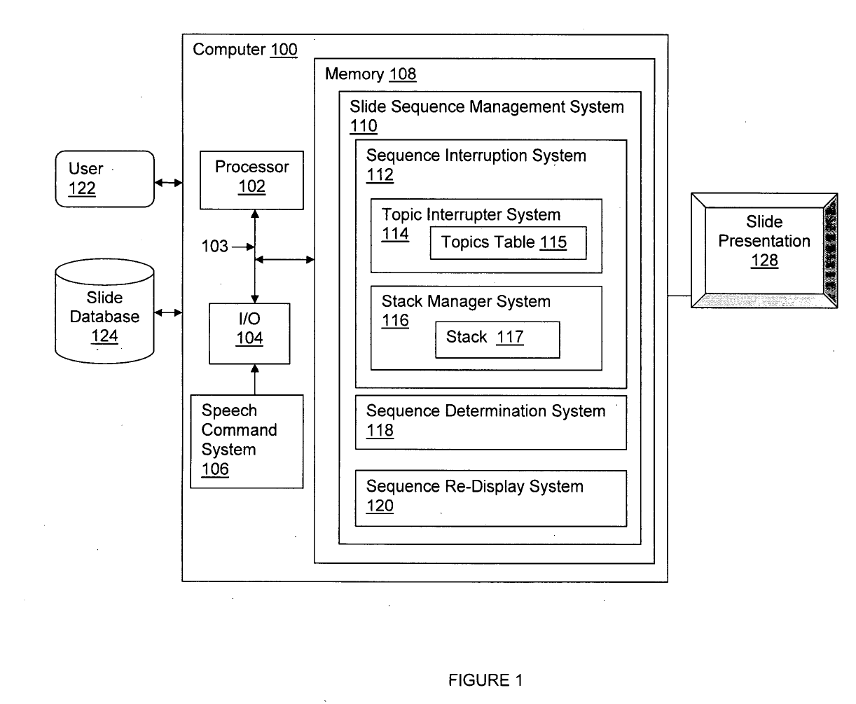

Referring now to the drawings, FIG. 1 depicts an embodiment of a slide sequence management system 110 for managing a non-linear slide presentation for a slide show program. Slide sequence management system 110 may be implemented as a software program product that can be stored in memory 108 and be executed on any type of computer system 100. In an illustrative embodiment, slide sequence management system 110 may comprise a speech command system 106 that provides a user the ability to direct the slide presentation 128 with voice commands. In another embodiment, slide sequence management system 110 may comprise a remote control device for the manual selection of the slide presentation 128. In another embodiment, slide sequence management system 110 may comprise a graphical user interface for selection of the slide presentation 128.

The slide presentation 128 component may be a slide presentation created and/or modified and/or displayed by/with a slide presentation product, such as the well-known POWERPOINT™ from Microsoft Corporation, LOTUS FREELANCE GRAPHICS™ from International Business Machines Corporation, or STAROFFICE™ from Sun Microsystems, Inc.

A sequence interruption system 112 is provided for interrupting a sequence of a slide presentation 128 and is comprised of a topic interrupter system 114 and a stack manager system 116. The interrupting of the sequence may be performed by the user 122 with any manual, automatic, or voice control methods and generally includes pausing the currrent sequence of the slide show and jumping to a new sequence, either in the current slide show or another slide show. In an embodiment of the invention, a command for causing an interrupt may include “Jump”, “Return” and “GoTo” commands. A person skilled in the art will readily recognize that any number of commands may be implemented to interrupt sequences and move to alternative sequences. In an embodiment of the invention, a speech command system 106 may be used by one or multiple speakers.

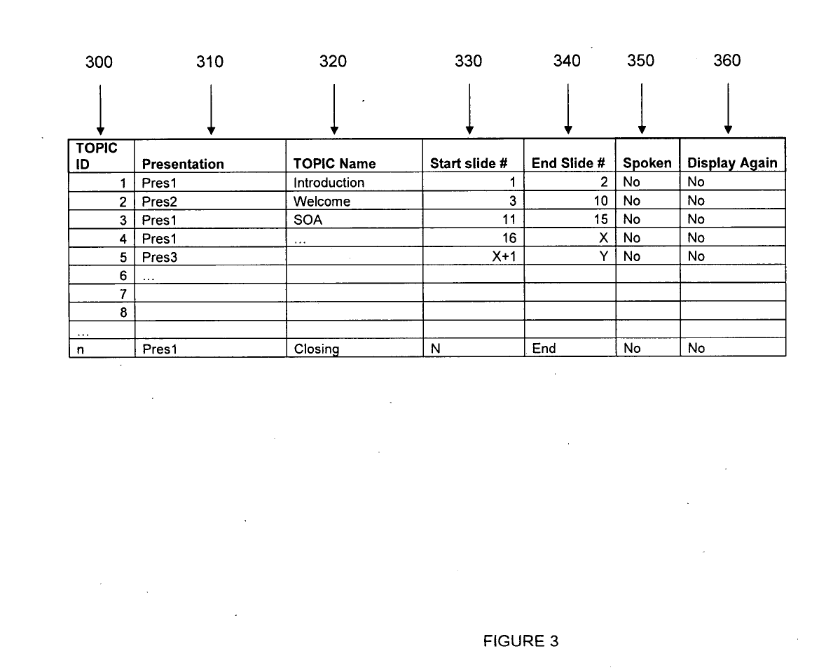

A topic interrupter system 114 is provided for maintaining a topics table 115 (FIG. 3). Referring to FIG. 3, the topics table 115 organizes the slide presentation 128 into one or more topic sequences 300. Each topic sequence 300 is assigned a start slide number 330 and an end slide number 340. Referring again to FIG. 1, when a user 122 interrupts the slide presentation 128, a topic interrupter system 114 marks a current slide by assigning an identifier to that slide. The topic interrupter system communicates the slide identifier to the stack manager system 116. The stack manager system 116 stores the slide identifier in a stack 117.

A sequence determination system 118 is provided for selecting a new topic sequence of the slide presentation 128. A new topic sequence generally comprises a set of slides that are not linearly contiguous with the current sequence. The sequence determination system 118 checks the topics table 115 to determine what slide to present for a new topic sequence. The selecting comprises presenting the next slide on the stack 117 or the next slide of a new topic sequence. When any slide sequence being presented is complete, the sequence determination system 118 checks the stack 117 for a slide identifier. The slide identifier is used as a reference point within a previously interrupted topic sequence. The slide presentation 128 continues at the point in a previously interrupted topic sequence and continues from that point.

In this way, any number of topic sequences may be presented in a non-linear manner during the course of a slide presentation 128. At the user's discretion, the user 122 may interrupt a current topic sequence and the topic interrupter system 114 assigns an identifier to a slide at a point of interruption. The stack manager system 116 places the slide identifier at the top of the stack 117 for the most recently interrupted topic sequence. The sequence determination system 118 either continues with the next slide in a new topic sequence or, if at the end of a topic sequence, checks the stack 117. The user 122 is able to easily move to one or more topic sequences and the system returns to the point in the presentation that was interrupted. Accordingly, no portion of the slide presentation 128 is lost and the user does not need to manually search for where a presentation was interrupted.

A sequence re-display system 120 is provided for storing each displayed slide presentation sequence. Slide presentations using the present invention may result in slide presentation sequences that were not previously contemplated by the user 122. For each slide presentation 128, the sequence re-display system 120 of the present invention stores the slide presentation sequence and provides a user 122 the ability to select a previous slide presentation sequence to use as the current slide presentation sequence.

In one embodiment of the invention, the user 122 prepares a slide presentation 128 by storing slides in a slide database 124. The slide database 124 may include but not be limited to digital slides or physical slides. The user may organize the slides into topics and store topic sequences of slides in a topics table 115. In an embodiment, a graphical user interface may allow a user 122 to modify topic sequences in the topics table 115.

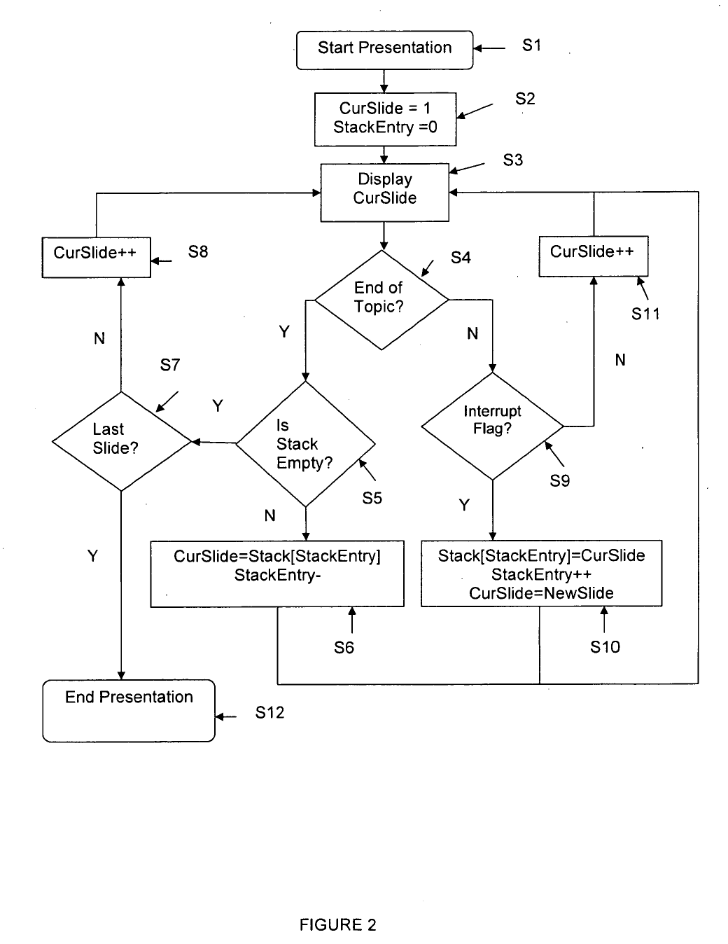

Referring now to FIG. 2, the process to manage a non-linear slide presentation as defined by the present invention is described. The process starts with the start of the slide presentation, S1. At this point there is a current slide (CurSlide=1) and no slides in the stack (StackEntry=0), S2. Next, the process displays the current slide (CurSlide=1), S3.

Next, the process determines if this slide is the end of a topic sequence, S4, e.g. by checking the topic table 115. If the topic sequence is at an end, the process determines if the stack is empty, S5. If the answer is no, then the next displayed current slide (CurSlide) is the next slide in the stack, S6. If the stack is empty, the process determines if current slide is the last slide in the sequence, S7. If yes, the slide presentation is at an end, S12. If no, the current slide is incremented to the next slide (CurSlide++), S8, which is then displayed, S3.

If the topic sequence is not at an end, the process determines if there is an interrupt flag, S9, indicating that the user has issued an interrupt command. If there is an interrupt flag, the current slide is stored in the stack, the stack entry point (StackEntry++) is incremented and the next displayed slide is the first slide in a new topic sequence of slides (CurSlide=New Slide), S10. If there is not an interrupt flag, the next current slide in the topic sequence (CurSlide++) is displayed S11.

Referring to FIG. 3, one embodiment of a topics table according to the present invention is illustrated. In this embodiment, each topic sequence is listed with a “Topic ID”, 300, a “Presentation” designation, 310, a “Topic Name”, 320, the first slide in the topic sequence “Start Slide #”, 330, and the last slide in the topic sequence “End Slide #”, 340. The information in the topics table thus allows the slide sequence management system 110 (FIG. 1) to determine where a topic sequence begins and ends, as well as associating a name and ID to each topic sequence. It should be noted that topic sequences can be used from different slide presentations, e.g. “Pres 1, Pres 2, etc.”

The illustrated embodiment of the topics table includes an exception column for “Spoken”, 350. A ‘yes’ entry allows a topic sequence to be displayed upon speaker command. A ‘no’ entry prevents a topic sequence to be displayed upon speaker command.

The illustrated embodiment of the topics table also includes an exception column labeled “Display Again”, 360. A ‘no’ entry prevents a topic sequence from being displayed more than once. A ‘yes’ entry allows a topic sequence to be displayed more than once.

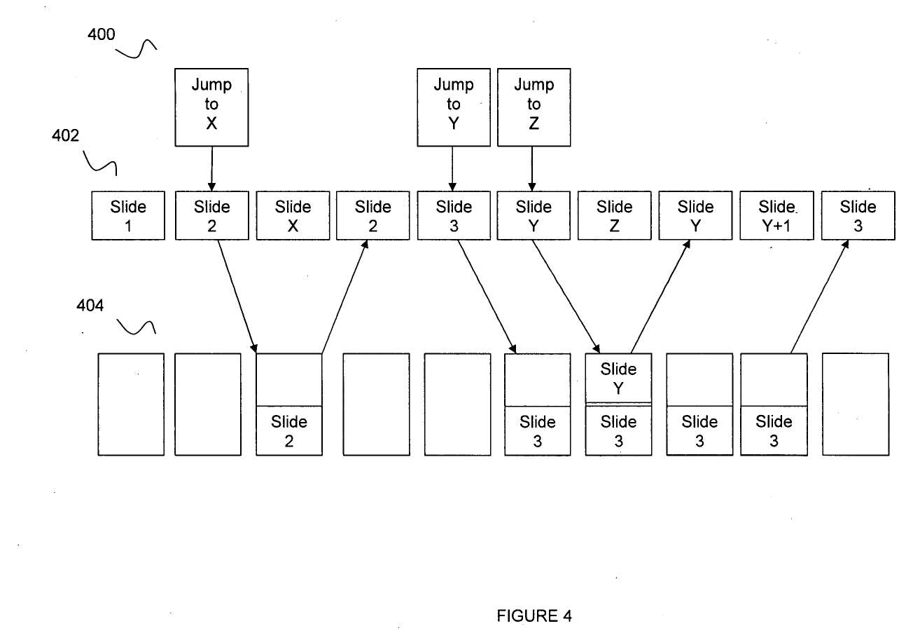

Referring to FIG. 4, an illustration of a non-linear slide show presentation in accordance with the present invention is depicted. Three rows are illustrated: the top row illustrates user commands 400, the middle row illustrates the slide presentation 402, and the bottom row illustrates a stack for slide identifiers 404. A conventional slide presentation moves through slides in a linear sequence (i.e. Slide 1, Slide 2, Slide n, Slide n+1 . . . . End). A non-linear slide presentation provides the option to a user to move through topics in a non-linear sequence. Referring to FIG. 4 as an illustration, a slide presentation begins at “Slide 1”. At “Slide 2” a user commands “Jump to X”. A slide identifier for “Slide 2” is placed in a stack. “Slide X” is displayed. It should be understood that “Slide X” could be one slide or a sequence of slides. After the sequence associated with “Slide X” is completed, “Slide 2” is identified as the slide identifier most recently placed on the stack and the sequence including “Slide 2” is begun again. Then “Slide 3” is displayed. The user commands “Jump to Y” and a slide identifier for “Slide 3” is placed in a stack. Then “Slide Y” is displayed. The user commands “Jump to Z” and a slide identifier for “Slide Y” is placed in the stack. Then “Slide Z” is displayed. After the sequence associated with “Slide Z” is completed, “Slide Y” is identified as the slide identifier most recently placed on the stack and the sequence including “Slide Y” is begun again. Then “Slide Y+1” is displayed. After “Slide Y+1”, which is the last slide in the sequence, is completed, “Slide 3” is identified as the slide identifier most recently placed on the stack and the sequence including “Slide 3” is begun again. Thus, the process allows for the nesting of slide presentation interruptions.

In embodiments of the invention, a user 122 may define topic sequences in a slide presentation 128 based on a pre-defined list of slides.

In an embodiment of the invention, a user 122 may mark a slide for return during a slide presentation 128, one or more times during a slide presentation 128, with a pre-defined: gesture, sentence or word (for example using speech, keyboard stroke, or mouse gesture or click.

In an embodiment of the invention, a user 122 may display the content of a topic sequence as a slide presentation 128 with the use of voice command.

In an embodiment of the invention, a user 122 may return to a marked slide with the use of voice command, thereby avoiding or not displaying a topic sequence.

In an embodiment of the invention, the order of every slide presentation 128 is saved and a user 122 may use a previous order of slide presentation 128 as the preferred slide presentation sequence. Referring again to FIG. 1, it is understood that computer system 100 may be implemented as any type of computing infrastructure. Computer system 100 generally includes a processor 102, input/output (I/O) 104, memory 108, and bus 103. The processor 102 may comprise a single processing unit, or be distributed across one or more processing units in one or more locations, e.g., on a client and server. Memory 108 may comprise any known type of data storage and/or transmission media, including magnetic media, optical media, random access memory (RAM), read-only memory (ROM), a data cache, a data object, etc. Moreover, memory 108 may reside at a single physical location, comprising one or more types of data storage, or be distributed across a plurality of physical systems in various forms.

I/O 104 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 103 provides a communication link between each of the components in the computer system 100 and likewise may comprise any known type of transmission link, including electrical, optical, wireless, etc. Although not shown, additional components, such as cache memory, communication systems, system software, etc., may be incorporated into computer system 100.

Access to computer system 100 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 100 comprising a slide sequence management system 110 could be created, maintained and/or deployed by a service provider that offers the functions described herein for customers.

It is understood that in addition to being implemented as a system and method, the features may be provided as a program product stored on a computer-readable medium, which when executed, enables computer system 100 to provide a slide sequence management system 110. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer readable medium according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for non-linear slide presentations, comprising:
interrupting a topic sequence of a slide presentation being currently shown;
placing a slide identifier from the interrupted topic sequence on a stack;
showing a new topic sequence of the slide presentation; and
upon completion of the new topic sequence of the slide presentation, returning to the interrupted topic sequence by examining the stack to obtain the slide identifier from the interrupted topic sequence.

2. The method of claim 1, further comprising:
interrupting the new topic sequence of the slide presentation while the new topic sequence is being shown;
placing a second slide identifier from the interrupted new topic sequence on the stack;
showing a second new topic sequence; and
upon completion of the new topic sequence of the slide presentation, returning to the interrupted new topic sequence by examining the stack to obtain the second slide identifier from the interrupted new topic sequence.

3. The method of claim 2, further comprising:
repeating the interrupting, placing and showing, for each new topic sequence; and
completing the presentation of each new topic sequence and returning to the slide identifier of the previously interrupted new topic sequence on the stack.

4. The method of claim 1, wherein the interrupting step further comprises input from a user.

5. The method of claim 4, wherein the input from the user includes speech commands.

6. The method of claim 1, further comprising storing each displayed slide presentation sequence.

7. The method of claim 6, further comprising selecting a previously displayed slide presentation sequence for a current slide presentation.

8. A slide sequence management system for non-linear slide presentations, comprising:
a sequence interruption system for interrupting a topic sequence of a slide presentation being currently shown;
a stack manager system for placing a slide identifier from the interrupted topic sequence on a stack; and
a sequence determination system for:
showing a new topic sequence of the slide presentation; and
upon completion of the new topic sequence of the slide presentation, returning to the interrupted topic sequence by examining the stack to obtain the slide identifier from the interrupted topic sequence.

9. The system of claim 8, further comprising:
a sequence interruption system for interrupting the new topic sequence of the slide presentation while the new topic sequence is being shown;
a stack manager system for placing a second slide identifier from the interrupted new topic sequence on the stack; and
a sequence determination system for:
showing a second new topic sequence; and
upon completion of the new topic sequence of the slide presentation,
returning to the interrupted new topic sequence by examining the stack to obtain the second slide identifier from the interrupted new topic sequence.

10. The system of claim 9, further comprising:
repeating the interrupting, placing and showing, for each new topic sequence; and
completing the presentation of each new topic sequence and returning to the slide identifier of the previously interrupted new topic sequence on the stack.

11. The system of claim 8, wherein the system for interrupting further comprises receiving input from a user.

12. The system of claim 11, wherein receiving input from the user includes a system for recognizing speech commands.

13. The system of claim 8, further comprising a sequence re-display system for storing each displayed slide presentation sequence.

14. The system of claim 13, further comprising selecting a previously displayed slide presentation sequence for a current slide presentation.

15. A computer readable medium having a program product stored thereon for non-linear slide presentations, the computer readable medium comprising program code for performing the following steps when executed on a computer system:
interrupting a topic sequence of a slide presentation being currently shown;
placing a slide identifier from the interrupted topic sequence on a stack;
showing a new topic sequence of the slide presentation; and
upon completion of the new topic sequence of the slide presentation, returning to the interrupted topic sequence by examining the stack to obtain the slide identifier from the interrupted topic sequence.

16. The computer readable medium of claim 15, further comprising comprising program code for performing the following steps:
interrupting the new topic sequence of the slide presentation while the new topic sequence is being shown;
placing a second slide identifier from the interrupted new topic sequence on the stack;
showing a second new topic sequence; and
upon completion of the new topic sequence of the slide presentation, returning to the interrupted new topic sequence by examining the stack to obtain the second slide identifier from the interrupted new topic sequence.

17. The computer readable medium of claim 16, further comprising:
repeating the interrupting, placing and showing, for each new topic sequence; and
completing the presentation of each new topic sequence and returning to the slide identifier of the previously interrupted new topic sequence on the stack.

18. The computer readable medium of claim 15, wherein the interrupting step further comprises input from a user.

19. The computer readable medium of claim 18, wherein the input from the user includes speech commands.

20. The computer readable medium of claim 15, further comprising storing each displayed slide presentation sequence.

21. The computer readable medium of claim 20, further comprising selecting a previously displayed slide presentation sequence for a current slide presentation.
